(19) United States
(12) Patent Application Publication
(10) Pub. No.: US 2004/0128539 A1
(43) Pub. Date: Jul. 1, 2004

(54) Method and apparatus for denial of service attack preemption

(75) Inventor: Tariq Shureih, Tigard, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Intel Corporation

(21) Appl. No.: 10/331,857

(22) Filed: Dec. 30, 2002

(51) Int. Cl. G06F 11/30

(52) U.S. Cl. 713/201

(57) ABSTRACT

Denial of service attack preemption determines with a system's operating system if a set of one or more protocol data units (PDUs) satisfy a set of one or more network security alert criteria. The set of network security alert criteria define characteristics of PDUs typical for PDUs used for initiating or conducting a denial of service attack. If one or more of the set of network security alert criteria are satisfied, then the system's transmission capability is adjusted and an alert is transmitted to a monitor.

### BACKGROUND

1. Field

Embodiments of the invention relate to the field of communication networks, more specifically, the invention relates to network security.

2. Background

A denial of service attack (DoS) is an attempt by a hacker to prevent legitimate users of a service or resource from accessing the service or resource. A DoS attack can be launched directly from a system, from a comprised system, or from several compromised systems (i.e., a distributed denial of service attack (DDoS)).

In addition to the different techniques for launching DoS attacks, DoS attacks can be performed in different ways. Some examples of ways to perform a DoS attack include: flooding a network, disrupting a connection between two systems, and preventing an individual system from accessing a service.

Various network security devices are available to attempt to prevent DoS attacks. A network security device is inserted between external systems and a protected systems. Hence, a network security device that screens traffic for DoS attack traffic becomes a choke point to protected systems. The network security device analyzes all traffic from the Internet to distinguish legitimate traffic from DoS attack traffic. The cost of these network security devices can be relatively high. This relatively high cost can become prohibitive for a small entity or individual trying to protect their server(s), which provide a service or resource.

Instead, small entities and/or individuals typically rely on their Internet Service Providers (ISPs) to protect them from hackers. Unfortunately, ISPs typically do not want to bear the burden (in both cost and liability) of screening their customers' traffic for possible DoS attacks. Instead, a reflexive approach is taken. Once their customer discovers they are a victim of a DoS attack, their ISP attempts to trace the attack back to the source. Tracing an attack, though, is an incredible task. Hackers can initiate and/or orchestrate a DoS attack from his/her system via a compromised system, directly from a computer in a public network (e.g., a computer in a school computer lab), through a myriad of compromised systems that use other systems to launch DoS attacks, etc. If the service provider is able to trace an attack back through a few compromised systems, the service provider will most likely encounter a spoofed source address. Expending resources to capture packets, analyze packets, and trace packets for an unknown period of time until a spoofed source address is encountered is inefficient and fruitless.

### BRIEF DESCRIPTION OF THE DRAWINGS

The invention may best be understood by referring to the following description and accompanying drawings that are used to illustrate embodiments of the invention. In the drawings:

FIG. 1 is a conceptual diagram illustrating denial of service attack preemption according to one embodiment of the invention.

FIG. 2 is a diagram illustrating DoS attack preemption in a network environment according to one embodiment of the invention.

FIG. 3 is an exemplary flowchart for DoS attack preemption according to one embodiment of the invention.

FIG. 4 is an exemplary flowchart of DoS attack preemption for forbidden PDUs and suspicious PDUs according to one embodiment of the invention.

FIG. 5 is an exemplary flowchart for DoS attack preemption without forbidden PDUs according to one embodiment of the invention.

FIG. 6 is a block diagram illustrating one embodiment of a computer system according to one embodiment of the invention.

### DETAILED DESCRIPTION OF THE DRAWINGS

In the following description, numerous specific details are set forth. However, it is understood that embodiments of the invention may be practiced without these specific details. In other instances, well-known circuits, structures and techniques have not been shown in detail in order not to obscure understanding of this description.

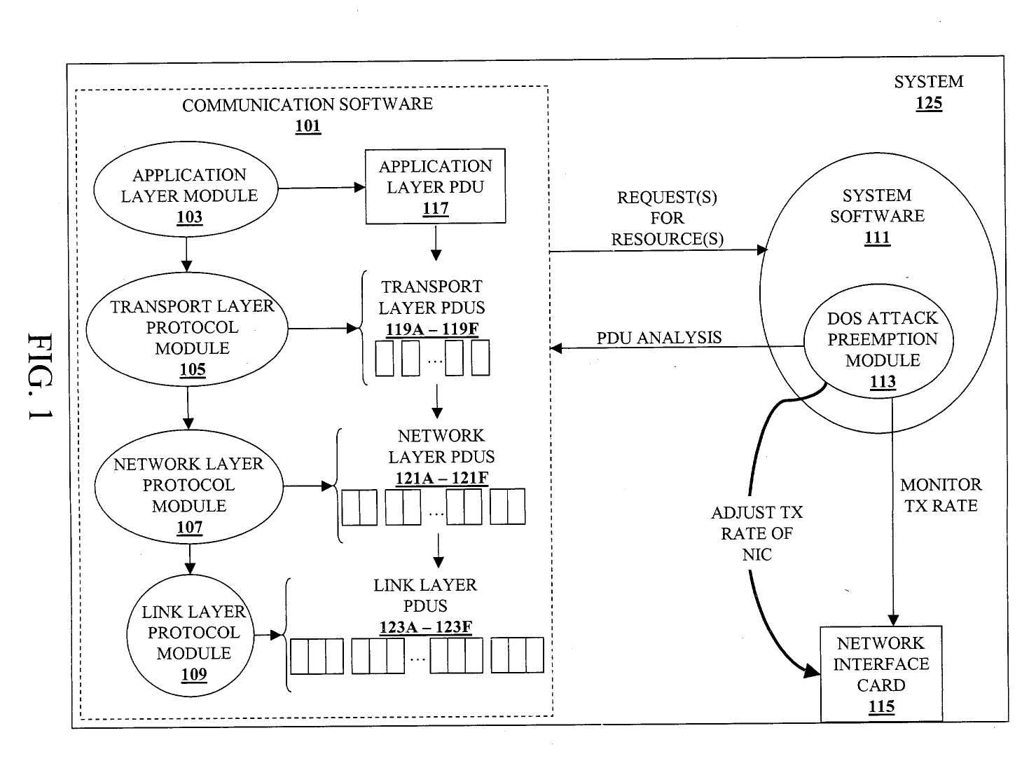

FIG. 1 is a conceptual diagram illustrating denial of service attack preemption according to one embodiment of the invention. In FIG. 1, a system 125 includes communication software 101, system software 111, and a network interface card 115. The communication software 101 includes an application layer module (e.g., a browser), a transport layer protocol module 105 (e.g., Transmission Control Protocol), a network layer protocol module 107 (e.g., Internet Protocol), and a link layer protocol module 109 (e.g., Ethernet). Although FIG. 1 illustrates the communication software 101 as including multiple modules, the modules may be independent. For example, the network layer protocol module 105 and the transport layer protocol module 107 may be combined into software that is independent of the link layer protocol module 109 (e.g., the a TCP/IP software suite and Ethernet software). The communication software 101 requests resources, including the network interface card 115, from the system software 111. The system software 111 (e.g., UNIX, Windows, MacX, etc.) includes a denial of service (DoS) attack preemption module 113 (e.g., the DoS attack preemption module is in the kernel of the system software 111). Implementing the DoS attack preemption module in the kernel of system software will prevent most hackers from tampering with the DoS attack preemption module since it is in lower level software and requires administrative authority to access it. Even if administrative access is gained by hackers, disabling such a module in low-level kernel space would require a system reboot. In one embodiment of the invention, the DoS attack preemption module and/or the kernel generates an alarm and/or error when such un-attended or non-scheduled event occurs.

The DoS attack preemption module 113 analyzes protocol data units (PDUs) generated by the communication software 111 and monitors the transmission rate of the network interface card 115. While in one embodiment of the invention the DoS attack preemption module 113 monitors the transmission rate of a physical network interface (e.g., a network interface of an Ethernet card), in alternative embodiments of the invention the DoS attack preemption module 113 monitors the transmission rate of logical or soft interfaces (e.g., an IP interface).

In FIG. 1, the application layer module 103 generates an application layer PDU 117. The transport layer protocol module 105 takes the application layer PDU 117 and generates transport layer PDUs 119A-119F. For example, if the transport layer protocol module 105 is a TCP module and the application layer PDU 117 is larger than the payload allowed by TCP, then the application layer PDU 117 is fragmented. Each fragment of the application layer PDU 117 is encapsulated with TCP information, thus becoming TCP packets. The network layer protocol module 107 takes the transport layer PDUs 119A-119F and generates network layer PDUs 121A-121F. For example if the network layer protocol module 107 is an IP module, then each of the transport layer PDUs 119A-119F are encapsulated with IP information. The link layer protocol module 109 takes the network layer PDUs 121A-121F and generates link layer PDUs 123A-123F. For example, if the link layer protocol module 109 is an Ethernet module, then the Ethernet module generates Ethernet frames by encapsulating each of the network layer PDUs 121A-121F with Ethernet information.

The DoS attack preemption module 113 analyzes PDUs generated by the communication software 101 to determine if any of the PDUs are suspicious (i.e., a packet with characteristics of a packet used for initiating or orchestrating a DoS attack). The manner of performing analysis, which PDUs are analyzed, and when the analysis is performed can be implemented in a variety of ways.

A variety of techniques can be used to implement the manner of determining if a PDU is suspicious. In one embodiment of the invention, each PDU is analyzed and compared against a set of one or more alert criteria that define a suspicious packet. The DoS attack preemption module may determine a PDU to be suspicious if all of the set of alert criteria are satisfied or if only certain of the alert criteria are satisfied. In another embodiment of the invention, a stream of PDUs is analyzed to determine if the stream is suspicious. Statistics are maintained on the stream of PDUs and the statistics are compared against a set of alert criteria to determine if the stream of PDUs is suspicious.

In addition to various techniques for determining if a PDU is suspicious, different embodiments of the invention perform the analysis on different PDUs. In one embodiment of the invention, the DoS attack preemption module 113 analyzes the link layer PDUs 123A-123F before they are transmitted via the network interface card 115. The DoS attack preemption module 113 may analyze PDUs at higher layers in addition to the link layer PDUs or instead of the link layer PDUs. In one embodiment of the invention, the DoS attack preemption module 113 is designed to only analyze source and destination addresses at the network layer. In an alternative embodiment of the invention, the DoS attack preemption module 113 is designed to analyze port information at the transport layer and address information at the network layer. In another embodiment of the invention, the DoS attack preemption module 113 analyzes ports, source addresses, and MAC addresses of PDUs before transmission.

The DoS attack preemption module 113 can be implemented with a variety of techniques to trigger analysis. In one embodiment of the invention, the DoS attack preemption module 113 analyzes PDUs upon request for the network interface card 115. In another embodiment of the invention, the DoS attack preemption module 113 analyzes a sampling of PDUs before transmission upon receiving a request for the network interface card 115. In another embodiment of the invention, the DoS attack preemption module 113 analyzes PDUs in response to the system software 111 receiving a request for any resource from certain modules of the communication software 101.

If the DoS attack preemption module 113 determines that one of the PDUs generated by the communication software 101 is suspicious according to its set of alert criteria and that the transmission rate of the network interface card 115 exceeds a predetermined threshold, then the DoS attack preemption module 113 adjusts the transmission rate of the network interface card 115 (e.g., throttles the transmission rate). In another embodiment of the invention the DoS attack preemption module 113 prevents the network interface card 115 from transmitting PDUs (i.e., shuts down the network interface) if one or more the PDUs is determined to be forbidden by the set of alert criteria (e.g., a packet has a spoofed source address). A forbidden PDU satisfies certain of the alert criteria that indicate characteristics of a PDU that is always or has a very high likelihood of being used to orchestrate or perform a DoS attack.

As can be seen with the illustration of FIG. 1, DoS attack preemption avoids tracing back an attack because the attack is preempted at its source. Either a DoS attack cannot be initiated because the network interface is shutdown, or an attempted DoS attack is debilitated because the transmission rate of the network interface is throttled.

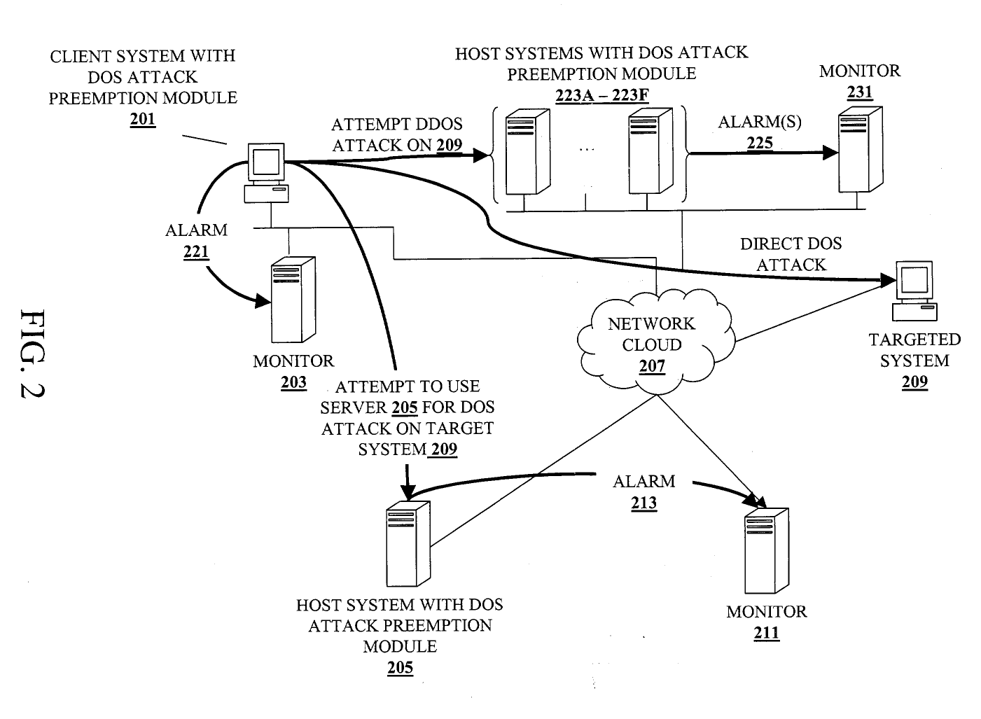

FIG. 2 is a diagram illustrating DoS attack preemption in a network environment according to one embodiment of the invention. In FIG. 2, a client system 201 has a DoS attack preemption module. A host system 205 also has a DoS attack preemption module. The client system 201 is coupled with a monitor 203 and a network cloud 207. The host 205 is also coupled with the network cloud 207. A monitor 211 is also coupled with the network cloud 207. The monitor 211 monitors traffic transmitted over a network that includes the host system 205. The network cloud 207 is also coupled with a targeted system 209, which can either be a host or client system) and a set of host systems 223A-223F, which can alternatively be client systems or a mix of client and host systems. Each of the host systems 223A-223F also has a DoS attack preemption module. In addition, a monitor 231 is coupled with the network that includes the host systems 223A-223F.

If a direct DoS attack is attempted on the targeted system 209 from the client system 201, then the DoS attack preemption module on the client system 201 will adjust the transmission capability of the client system 201 and transmit an alarm 221 to the monitor 203. If a DoS attack is attempted from the client system 201 using the host system 205 on the targeted system 209, then the DoS attack preemption module on the host system 205 will adjust the transmission capability of the host system and transmit an alarm 213 to the monitor 211. Alternatively, if a distributed DoS (DDOS) attack is attempted on the client 209 with the host systems 223A-223F from the client system 209, then once one or more of the host systems 223A-223F determine that alert criteria have been satisfied with their DoS attack preemption modules, then those of the host systems 223A-223F that determine that the alert criteria have been satisfied adjust their transmission capabilities accordingly, and an alarm(s) 225 is transmitted to the monitor 231.

Although installing the DoS attack preemption module on the client system in FIG. 2 will preempt DoS attacks initiated and/or orchestrated from that client system, placing the DoS attack preemption module in various places throughout networks provides additional preemptive capabilities. For example, if a single packet from a client system does not satisfy alert criteria on the client system, but the packet is used to initiate a DoS attack on a different system(s), then a DoS attack preemption module on the compromised system(s) will detect the suspicious packets and transmission rate exceeding the predefined threshold and preempt the attack from being initiated from the remote client system. Implementation of DoS attack preemption in a client and/or host inhibits the ability of hackers to orchestrate/initiate DoS attacks either directly or remotely.

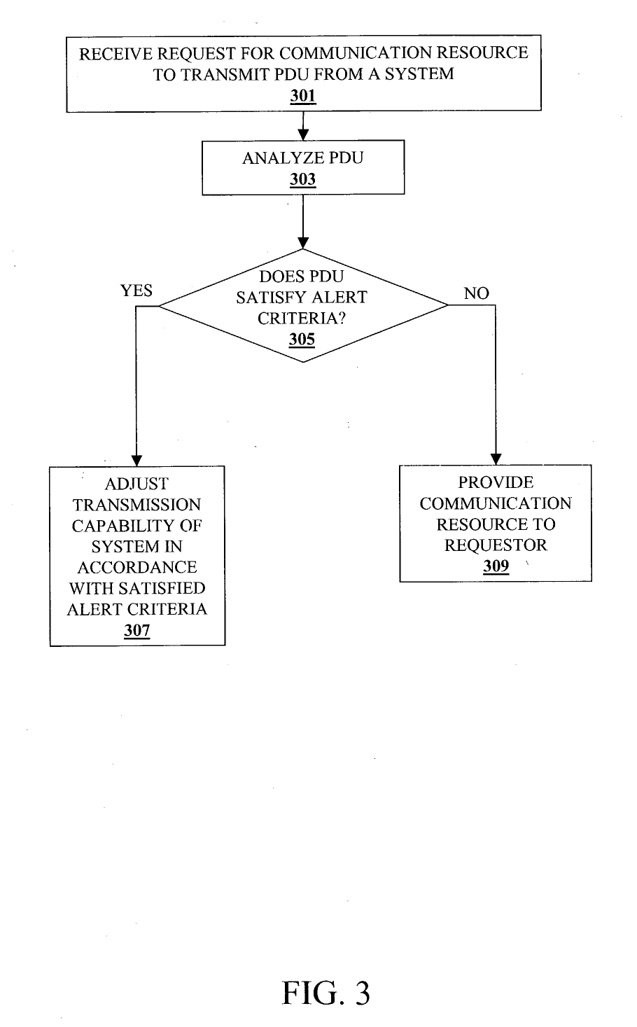

FIG. 3 is an exemplary flowchart for DoS attack preemption according to one embodiment of the invention. At block 301, a request for a communication resource to transmit a PDU from a system is received. At block 303, the PDU is analyzed. At block 305, it is determined if the PDU satisfies a set of alert criteria. If the PDU does not satisfy one or more of the set of alert criteria, then control flows to block 309. If the PDU does satisfy one or more of the set of alert criteria, then control flows to block 307.

At block 309, the communication resource is provided to the requester.

At block 307, the transmission capability of the system is adjusted in accordance with the satisfied alert criteria (e.g., if the PDU is deemed forbidden, then the transmission capability is shut down, if the PDU is not forbidden but suspicious, then the transmission capability is reduced, etc.).

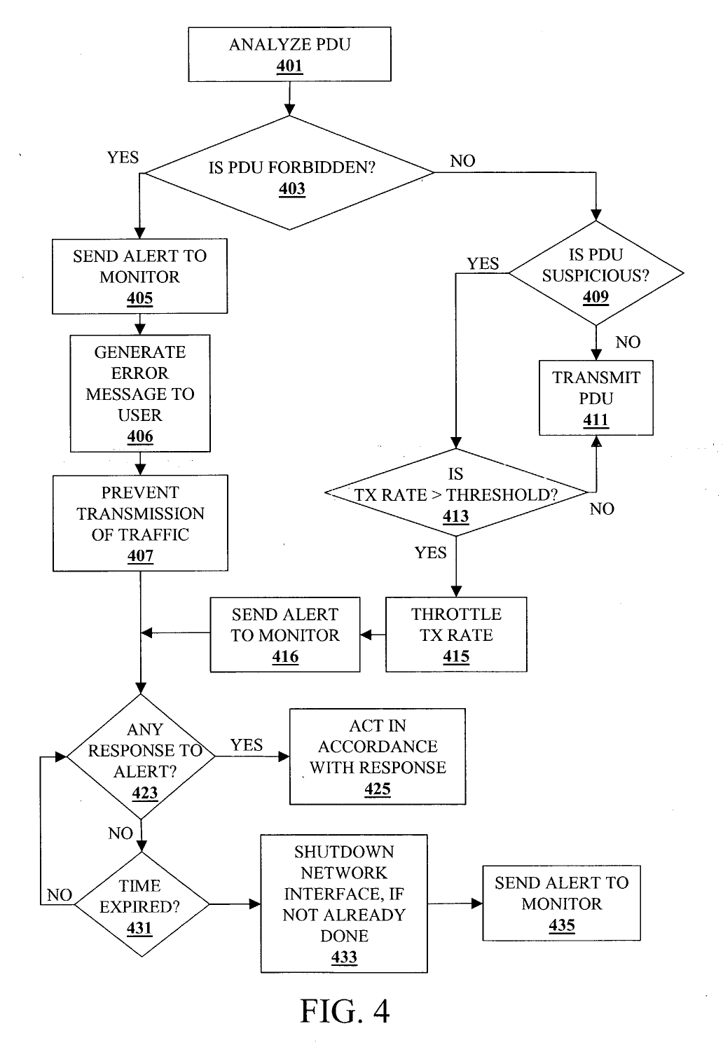

FIG. 4 is an exemplary flowchart of DoS attack preemption for forbidden PDUs and suspicious PDUs according to one embodiment of the invention. At block 401, a PDU is analyzed. At block 403, it is determined if the PDU is a forbidden PDU (e.g., the PDU indicates a spoofed address). If the PDU is a forbidden PDU, then control flows to block 405. If the PDU is not a forbidden PDU, then control flows to block 409.

At block 405, an alert is sent to a monitor. At block 406, an error message is generated for a user. In alternative embodiments, the error message is generated for an administrator, not generated, or logged but not generated. At block 407, transmission of traffic is prevented (e.g. the network interface is shut down). At block 423, it is determined if there has been a response to the alert (e.g., corrective action, response message received from the monitor, an administrator performing some action, etc.). If there has not been a response to the alert, then control flows back to block 431. If there has been a response to the alert, then a control flows to block 425.

At block 425, operations are performed in accordance with the response (e.g., the network interface is shutdown, all traffic is logged, the current username is recorded, the system is locked until an administrator releases it, the communication capabilities of the system are locked until an administrator releases them, etc.).

At block 431, it is determined if a predefined time has expired. If the time has not expired, then control flows back to block 423. If the time has expired, then control flows to block 433. At block 433, the network interface is shut down, if it has not already been shut down. At block 435, another alert (e.g., the same alert as the previous alert, a higher level alert, an alert that indicates the network interface has been shut down, etc.) is sent to the monitor.

If at block 403 the PDU was determined not to be forbidden, then at block 409 it is determined if the PDU is suspicious. If the PDU is determined to be suspicious, then control flows to block 413. If the PDU is determined not to be suspicious, then control flows to block 411.

At block 411, the PDU is transmitted.

At block 413, it is determined if the transmission rate of the network interface to transmit the PDU is greater than a predetermined transmission rate threshold. If the transmission rate is not greater than the threshold, then control flows to block 411. If the transmission rate is greater than the threshold, then control flows block 415.

At block 415, the transmission rate is throttled (i.e., reduced). At block 416, an alert is transmitted to a monitor. Control flows from block 416 to block 423.

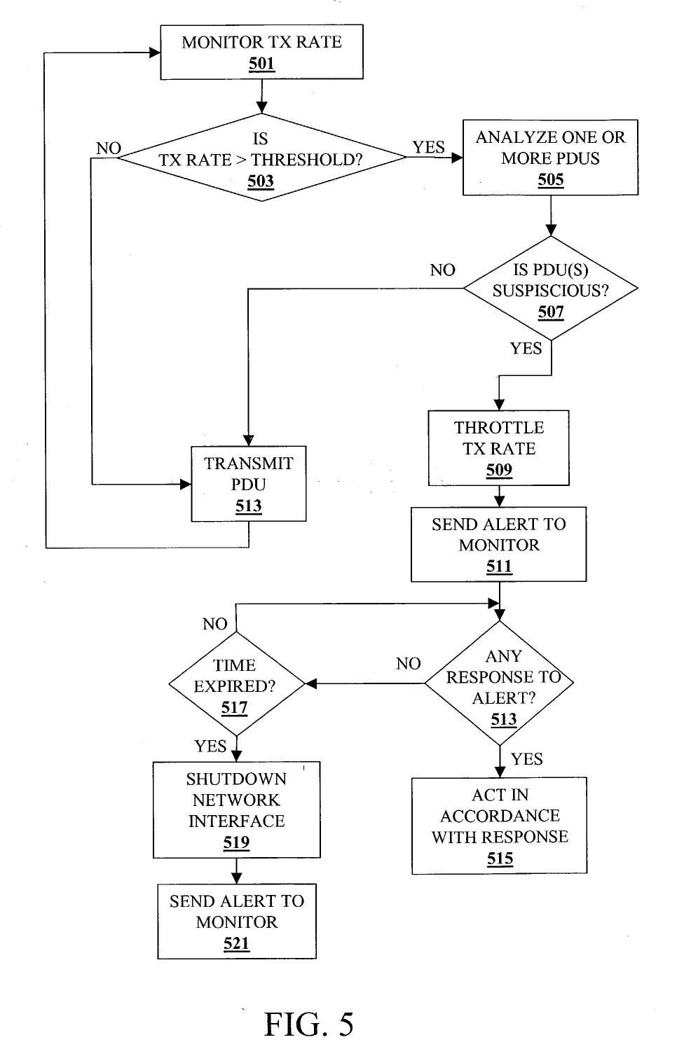

FIG. 5 is an exemplary flowchart for DoS attack preemption without forbidden PDUs according to one embodiment of the invention. At block 501, transmission rate of a network interface is monitored. At block 503, it is determined if the transmission rate of the network interface exceeds a predefined transmission rate threshold. If the transmission rate exceeds the threshold, then control flows to block 505. If the transmission rate does not exceed the threshold, then control flows to block 513.

At block 513, the PDU is transmitted. Control flows from block 513 back to block 501.

At block 505, one or more PDUs are analyzed. At block 507, it is determined if the analyzed PDUs are suspicious. If the analyzed PDUs are not suspicious, then control flows to block 513. If the analyzed PDUs are suspicious, then control flows to block 509.

At block 509, the transmission rate is throttled. At block 511, an alert is sent to a monitor. At block 513, it is determined if there has been a response to the alert. If there has been a response to the alert, then control flows block 515. If there's not been a response to the alert, then control flows block 517.

At block 515, operations are performed in accordance with the response.

A block 519, it is determined if a predefined time has expired. If the predefined time has expired, then control flows to block 519. If the predefined time has not expired, then control flows back to block 515.

At block 519, the throttled network interface is shutdown. Control flows from block 519 to block 521. At block 521, an alert is sent to the monitor.

In an alternative embodiment of the invention, if there is not a response to the alert then the throttled or shut down network interface is returned to its previous state and no further alerts are transmitted. In another embodiment of the invention, the network interface is returned to its previous state, but alerts are transmitted to the monitor until a response or correction action has been taken. In another embodiment of the invention, the network interface is shutdown without any further checks for responses if a response is not received within the predefined time.

While the flow diagrams in the Figures show a particular order of operations performed by certain embodiments of the invention, it should be understood that such order is exemplary (e.g., alternative embodiments may perform certain of the operations in a different order, combine certain of the operations, perform certain of the operations in parallel, etc.). For example, in an alternative embodiment of the invention, block 407 of FIG. 4 is performed before blocks 405 and 406 and the alert is transmitted via a different interface (e.g., a serial port connected to a monitor if the network interface that is shut down is a physical interface). In another embodiment of the invention, block 416 is performed before block 415. Referring to FIG. 5, block 511 is performed before block 509 in one embodiment of the invention.

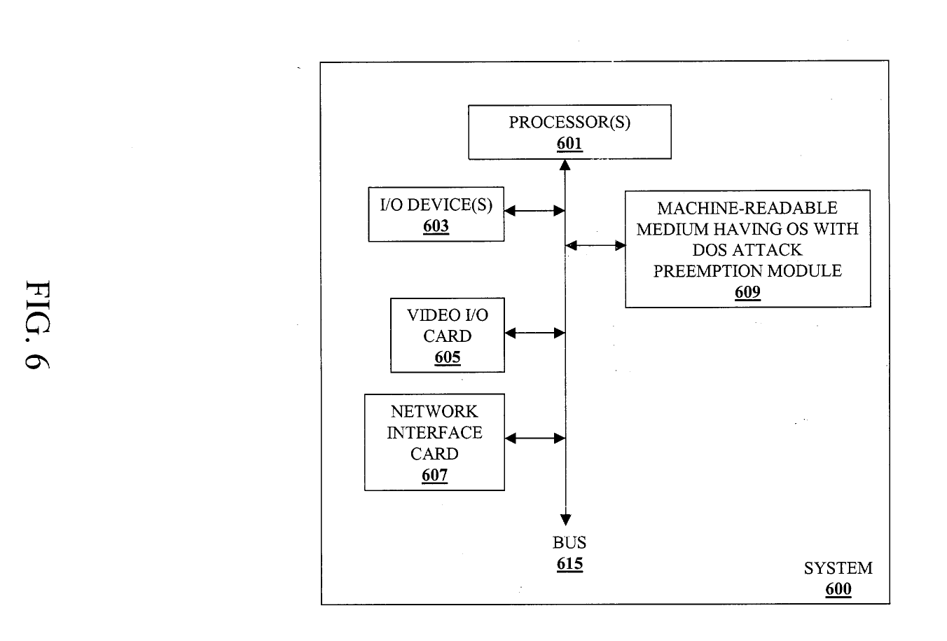

FIG. 6 is a block diagram illustrating one embodiment of a computer system according to one embodiment of the invention. The computer system 600 comprises a processor(s) 601, a bus 615, I/O devices 603 (e.g., keyboard, mouse), and a network interface card 607 (e.g., an Ethernet card, an ATM card, a wireless network card, etc.). The processor(s) 601, the I/O devices 603, and the network interface card 607 are coupled with the bus 615. The processor(s) 601 represents a central processing unit of any type of architecture, such as CISC, RISC, VLIW, or hybrid architecture. Furthermore, the processor(s) 601 could be implemented on one or more chips. The bus 615 represents one or more buses (e.g., AGP, PCI, ISA, X-Bus, VESA, HyperTransport, etc.) and bridges. While this embodiment is described in relation to a single processor computer system, the described invention could be implemented in a multi-processor computer system.

In addition, a machine-readable medium 609 having an operating system with a DoS attack preemption module is coupled with the bus 615. For the purpose of this specification, the term “machine-readable medium” shall be taken to include any mechanism that provides (i.e., stores and/or transmits) information in a form readable by a machine (e.g., a computer). A set of instructions (i.e., software) embodying any one, or all, of the methodologies described herein is stored on the machine-readable medium. Software can reside, completely or at least partially, within this machine-readable medium and/or within the processor and/or ASICs. For example, a machine-readable medium includes read only memory (“ROM”), random access memory (“RAM”) (e.g., DDR SDRAM, EDO DRAM, SDRAM, BEDO DRAM, etc.) magnetic disk storage media, optical storage media, flash memory devices, electrical, optical, acoustical, or other form of propagated signals (e.g., carrier waves, infrared signals, digital signals, etc.), etc.

In addition to other devices, one or more of a video card 605 may optionally be coupled to the bus 615. The video card 605 represents one or more devices for digitizing images, capturing images, capturing video, transmitting video, etc.

While the invention has been described in terms of several embodiments, those skilled in the art will recognize that the invention is not limited to the embodiments described, but may be practiced with modification and alteration within the spirit and scope of the appended claims. The description is thus to be regarded as illustrative instead of limiting.

What is claimed is:

1. A method comprising:
determining with a system's operating system if a set of one or more protocol data units (PDUS) satisfy a set of one or more network security alert criteria, wherein the set of network security alert criteria define characteristics of PDUs typical for PDUs used for initiating or conducting a denial of service attack; and
adjusting the system's transmission capability and transmitting an alert to a monitor if one or more of the set of network security alert criteria are satisfied.

2. The method of claim 1 wherein the kernel of the operating system performs the determining.

3. The method of claim 1 wherein adjusting the system's transmission capability comprises reducing the transmission rate of the system if the set of PDUs are determined to be suspicious according to the set of network security alert criteria and the transmission rate of the system exceeds a predefined threshold.

4. The method of claim 3 further comprising preventing the system from transmitting if one or more of the set of PDUs indicates a spoofed address.

5 The method of claim 1 wherein adjusting the system's transmission capability comprises the operating system adjusting a set of one or more network interfaces of the system.

6. The method of claim 1 wherein the set of network interfaces are physical and/or logical.

7. The method of claim 1 wherein the alert is a simple network management protocol alert.

8. The method of claim 1 wherein the PDUs are Internet Protocol packets and/or Ethernet frames.

9. A method comprising:
determining, with a denial of service attack preemption module included within a systems' system software, if a protocol data unit (PDU) generated by communication software is possibly being used to initiate or orchestrate a denial of service attack and if a transmit rate of the system is greater than a predetermined threshold transmit rate; and
transmitting an alert to a monitor and throttling the transmit rate if the PDU is suspicious and the transmit rate is greater than the predetermined threshold transmit rate.

10. The method of claim 9 wherein the communication software includes an Internet Protocol module and/or an Ethernet module.

11. The method of claim 9 further comprising preventing the system from transmitting if the PDU is determined to be forbidden.

12. The method of claim 11 wherein the PDU is determined to be forbidden because the PDU indicates a spoofed address.

13. The method of claim 9 wherein the denial of service attack preemption module is part of the kernel of the system software.

14. A method comprising:
at the kernel level of an operating system,
analyzing a protocol data unit (PDU) generated by communication software to be transmitted via a network interface,
reducing the transmit rate of the network interface if the analyzed PDU is determined to be suspicious for denial of service attacks and the transmit rate of the network interface exceeds a predetermined transmit rate threshold; and
transmitting the PDU via the network interface if the PDU is not suspicious.

15. The method of claim 14 wherein the PDU is an Internet Protocol packet or an Ethernet frame.

16. The method of claim 14 wherein the network interface is physical or logical.

17. The method of claim 14 further comprising shutting down the network interface if the analysis of the PDU determines that the PDU is forbidden.

18. An apparatus comprising:
a bus;
a set of one or more processors coupled with the bus;
an Ethernet network interface card coupled with the bus; and
a machine-readable medium coupled with the bus, the machine-readable medium having stored therein a set of instructions to cause the set of processors to, determine if a protocol data unit satisfies a set of one or more network
security alert criteria as a suspicious protocol data unit and if rate of transmission of a network interface to be used to transmit the suspicious protocol data unit exceeds a predetermined threshold, wherein the set of network security alert criteria define characteristics of protocol data units typical for protocol data units used for initiating or orchestrating denial of service attacks,
adjust the rate of transmission of the network interface if the protocol data unit is a suspicious protocol data unit and if the transmission rate exceeds the predetermined threshold.

19. The apparatus of claim 18 wherein the machine-readable medium is an optical storage device.

20. The apparatus of claim 18 wherein the set of instructions stored on the machine-readable medium further cause the set of processors to shut down the interface if the protocol data unit is determined to be forbidden in accordance with the set of network security alert criteria.

20. A machine-readable medium that provides instructions, which when executed by a set of one or more processors, cause said set of processors to perform operations comprising:
determining with a system's operating system if a set of one or more protocol data units (PDUs) satisfy a set of one or more network security alert criteria, wherein the set of network security alert criteria define characteristics of PDUs typical for PDUs used for initiating or conducting a denial of service attack; and
adjusting the system's transmission capability and transmitting an alert to a monitor if one or more of the set of network security alert criteria are satisfied.

21. The machine-readable medium of claim 20 wherein the set of instructions included in the kernel of the operating system.

22 The machine-readable medium of claim 20 wherein adjusting the system's transmission capability comprises the operating system adjusting a set of one or more network interfaces of the system.

23. The machine-readable medium of claim 20 further comprising preventing the system from transmitting if one or more of the set of PDUs indicates a spoofed address.

24. The machine-readable medium of claim 20 wherein the set of network interfaces are physical and/or logical.

25. The machine-readable medium of claim 20 wherein the alert is a simple network management protocol alert.

26. The machine-readable medium of claim 20 wherein the PDUs are Internet Protocol packets and/or Ethernet frames.

27. A machine-readable medium that provides instructions, which when executed by a set of one or more processors, cause said set of processors to perform operations comprising:
at the kernel level of an operating system,
analyzing a protocol data unit (PDU) generated by communication software to be transmitted via a network interface,
reducing the transmit rate of the network interface if the analyzed PDU is determined to be suspicious for denial of service attacks and the transmit rate of the network interface exceeds a predetermined transmit rate threshold; and
transmitting the PDU via the network interface if the PDU is not suspicious.

28. The machine-readable medium of claim 27 wherein the PDU is an Internet Protocol packet or an Ethernet frame.

29. The machine-readable medium of claim 27 wherein the network interface is physical or logical.

30. The machine-readable medium of claim 27 further comprising shutting down the network interface if the analysis of the PDU determines that the PDU is forbidden.
